(19) United States
(12) Patent Application Publication
(10) Pub. No.: US 2004/0151076 A1
(43) Pub. Date: Aug. 5, 2004

(54) Programmable alarm clock with telephone sleep, individual wake up and computer interface

(76) Inventor: Howard F. Fidel, Irvington, NY (US)

Correspondence Address: David Aker, 23 Southern Road, Hartsdale, NY, 10530, US

(21) Appl. No.: 10/356,955

(22) Filed: Feb. 3, 2003

(51) Int. Cl. G04C 21/16; G04C 23/14; G04B 23/00

(52) U.S. Cl. 368/251

(57) ABSTRACT

An alarm clock with multiple weekly and independent daily schedule capability. Three types of alarms are available and selectable for each schedule: a built in AM/FM radio, a noise maker, such as a buzzer, and an under pillow vibrating pad. Each day of the week can be programmed independently so that the alarm need not be reset each day to accommodate a varying daily schedule. Two independent daily schedules are available, so that one device may be used for a couple. Different weekly schedules are available to accommodate rotating shift workers, or others that need to have different schedules from time to time. The alarm time can be changed just for the next day, without changing the normal alarm schedule. A built in or external telephone may be programmed with telephone off times so that sleep in not disturbed. A built in un-interruptible power supply allows the clock to continue to function during power outages.

### BACKGROUND OF THE INVENTION

1. Field of the Invention

This invention relates to alarm clocks. More particularly, it relates to alarm clocks that can be programmed with wake up times that vary from day to day. It also relates to alarm clocks that have more than one wake up time per day.

2. Prior Art

There have been various proposals for programmable alarm clocks. Generally such devices do not meet the needs of busy people, and in particular, busy couples, who may both have schedules that vary from day to day, or in an unpredictable manner. Further each member of the couple may have a different schedule on the same day. It would be desirable for each member to be awakened at a different time without waking up the other.

Another significant problem that many busy people face is the need to get an uninterrupted night of sleep without being awakened by telephone calls. As a matter of convenience, many people have telephones in their bedrooms. Often, people with demanding jobs seek to get a good, relatively long night of sleep. These individuals may turn in early, at a time well before even considerate people stop making telephone calls to their friends and relatives. While not normally socially objectionable, such late evening telephone calls will interrupt the sleep of those who go to sleep at an early hour.

Still another problem with programmable alarm clocks is that they are generally not easy to program. A mistake in programming may cause someone to be late for or to miss an important meeting. If the alarm erroneously goes off at too early a time, such as on the weekend, a person may be deprived of the opportunity and pleasure of “sleeping in”, usually associated with not having to get up early to go to work.

### SUMMARY OF THE INVENTION

It is an object of this invention to provide an alarm clock that is easily programmable for schedules that vary from day to day or in an unpredictable manner.

It is another object of the invention to provide an alarm clock that can be used to awaken one member of a sleeping couple without awakening the other.

It is a further object of the invention to provide an alarm clock that disables a telephone from ringing during a sleep time so that the user or users can have an uninterrupted period of sleep.

These objects and others are achieved in accordance with the invention by an alarm clock which comprises a time keeping circuit; a display for displaying a time provided by the time keeping circuit; an alarm time memory including alarms for a first person and for a second person, the alarms for the first person and for the second person including a plurality of schedules, each schedule being separately programmable for a different time for each day of the week; a selector for selecting which of the schedules it to be an active alarm; and apparatus for making a person aware that an alarm time has been reached.

The alarm clock may further comprise an input device or entering an alternate alarm time to replace a single time for a single day of the week. The alternate alarm time may be used only once before the alarm clock reverts to a preselected schedule. After the alternate alarm time is used, an alarm is generated on a preexisting schedule.

The apparatus for making a person aware that an alarm time has been reached may include a pillow pad for at least one of the first person and the second person.

The alarm clock may further comprising a sound generating system. The sound generating system may include at least one of a radio receiver, a tape player, a CD player and a MP3 file player.

The alarm may further comprise a controller for controlling whether a telephone ringer is active between selected times of a day. The controller may render the telephone ringer active at the latest alarm time of alarm times selected by the selector.

The display of the alarm clock may comprise a portion for displaying when the telephone ringer is rendered inactive and when the telephone ringer is rendered active, by the controller.

The alarm clock may further comprise a telephone, and a controller for controlling whether a telephone ringer is active between selected times of a day. The display may comprise a portion for displaying when the telephone ringer is rendered inactive and when the telephone ringer is rendered active by the controller.

The display of the alarm clock may comprise portions for displaying current time, an alarm time for the first person and an alarm for the second person. The display may comprise portions for displaying which of the plurality of schedules has been selected for at least one of the first person and the second person. The display may comprise portions for displaying a current day of the week.

The invention is also directed to an alarm clock comprising a time keeping circuit; a display for displaying the time provided by the time keeping circuit; an alarm time memory for storing at least one first alarm time for a first person and at least one second alarm time for a second person; a first source of electrical energy being activated when the first alarm time is reached; a second source of electrical energy being activated when the second alarm time is reached; a first vibration source for placement in a first pillow responsive to set first source; and a second vibration source for placement in a second pillow responsive to the second source.

The alarms for the first person and for the second person may include a plurality of schedules, each schedule being separately programmable for a different time for each day of the week.

The invention also contemplates an alarm clock comprising a time keeping circuit; a display for displaying the time provided by the time keeping circuit; and a telephone sleep alarm, the telephone sleep alarm defining a start time and an end time, the alarm clock disabling a ringer on a telephone between the start time and the end time.

The alarm clock may further comprise an alarm time memory including an alarm time for a first person and an alarm time for a second person, the end time on a given day being a later of the alarm time for the first person and the alarm time for the second person.

The alarm clock may further comprise an alarm time memory including an alarm time for a first person and an alarm time for a second person, the end time on a given day being a predetermined default time if either of the alarm time for the first person and the alarm time for the second person is not selected.

The alarm clock may further comprise an alarm time memory including alarms for a first person and for a second person, the alarms for the first person and for the second person including a plurality of schedules, each schedule being separately programmable for a different time for each day of the week.

The alarm clock may further comprise a telephone interface, the telephone interface including a telephone disable and restore circuit for disabling the telephone during a selected time; a sense circuit for detecting whether the telephone is off hook; and a restore circuit responsive to the sense circuit for operating the disable and restore circuit to reconnect the telephone so that a dial tone is available, and telephone calls can be made.

The alarm clock may further comprise a telephone, built into the alarm clock, and a disable circuit for disabling the ringer of the telephone between the start time and the end time.

The invention is also directed to an alarm clock comprising a time keeping circuit; a display for displaying the time provided by the time keeping circuit; an alarm time memory for storing a plurality of alarm times; and an interface for receiving a plurality of alarm times to be stored in the alarm time memory.

The interface may be configured to receive the alarm times from a digital device.

The invention is further directed to the alarm clock in combination with the digital device. The digital device may be one of a computer, a personal digital assistant and a memory stick. The interface may communicate with the digital device by one of an infra-red link, a radio link and a direct electrical connection. The direct electrical connection comprises an RS-232 or USB link.

The present invention is also directed to a method for operating an alarm clock, comprising programming a digital device with at least one schedule; and transferring the schedule to the alarm clock.

The method may further comprise setting the alarm clock to provide alarms in accordance with the alarm schedule. At least one schedule may comprise alarms for a first person and for a second person, the alarms for the first person and for the second person including a plurality of schedules, each schedule being separately programmable for a different time for each day of the week. The at least one schedule may comprise times for rendering a telephone ringer operative and inoperative.

### BRIEF DESCRIPTION OF THE DRAWINGS

The foregoing aspects and other features of the present invention are explained in the following description, taken in connection with the accompanying drawings, wherein:

FIG. 1 is a block diagram of an alarm clock in accordance with the invention and a computer system that may be used with the alarm clock.

FIG. 2 is a schematic diagram of a telephone interface for an alarm clock in accordance with the invention having an internal telephone.

FIG. 3 is a schematic diagram of a telephone interface for an alarm clock in accordance with the invention having an external telephone.

FIG. 4 is a representation of a screen displayed by software running on an external programming device that permits the alarm clock of FIG. 1 to be externally programmed.

### DETAILED DESCRIPTION OF THE PREFERRED EMBODIMENTS

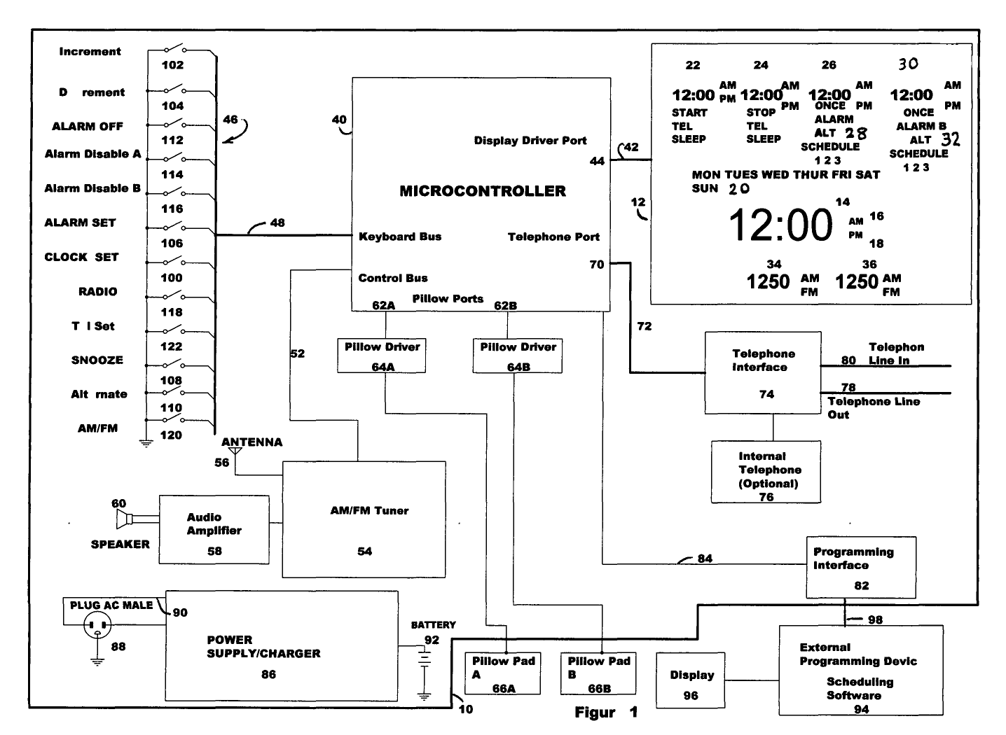

Referring to FIG. 1, there is shown a block diagram of an apparatus 10 incorporating features of the present invention. Although the present invention will be described with reference to the embodiments shown in the drawings, it should be understood that the present invention can be embodied in many alternate forms of embodiments. In addition, any suitable size, shape or type of elements or materials could be used.

Referring to FIG. 1, an alarm clock radio 10 according to the invention includes a display 12 having the usual display functions associated with alarm clocks and several functions in accordance with the invention. Display 12 may be, for example, a back illuminated liquid crystal display of a type well known in the art. Digits 14 display the current time, in association with indicators 16 and 18 for AM and PM respectively. A series of indicators 20 provide information as to which is the current day of the week. Indicators 22 and 24 provide information as to the time a telephone sleep period is programmed to start and to end, respectively. An indicator 26 displays the wake up time for a single day for a first user designated as user A. An alternate schedule indicator 28 displays which of three different pre-stored schedules for user A has been selected, as described in more detail below. Indicators 30 and 32 are analogous to indicators 26 and 28, but are for a second user, designated as user B. Indicator 34 displays a selected radio frequency that has been tuned to for normal listening. Indicator 36 displays the radio frequency that has been selected as an alarm or wake up frequency. In this manner, the wake up frequency may be tuned to a radio station that provides local weather and traffic information that is important to receive when awakening to travel to work. On the other hand, the frequency selected for listening and displayed on indicator 36 may be one that is commonly selected for listening pleasure, rather than for particular information content.

Display 12 is controlled by a microprocessor or micro controller 40 (such as, for example, an ST62T40B by STM Electronics) via a display driver bus connected to a display driver port 44. Microcontroller 40 also controls, in general, all functions of radio 10. Microcontroller 40 is also connected to a keyboard 46 via a keyboard connection bus 48, which is in turn connected to a keyboard interface of microcontroller 40. A control bus 52 connects microcontroller 40 to an AM/FM tuner module 54, (such as, for example a TEAS6846 by Phillips Electronics). An appropriate internal antenna 56 is connected to tuner module 54 to allow for reception of radio signals, on for example, the normal AM and FM bands. The audio output of module 54 is connected to an audio amplifier 58, which is in turn connected to a speaker 60 to provide audio to listeners in proximity to clock radio 10, as is well known in the art.

Mircocontroller 40 includes two logic ports that are referred to herein as pillow ports 62A and 62B. Ports 62A and 62B provide logic signals to pillow drivers 64A and 64B, respectively. These drivers provide electrical signals to pillow pads 66A and 66B, for users A and B respectively. Thus a vibrational signal, or wake up tone of low amplitude, can be sent to pillow pads 66A and 66B at separate times to wake one of the sleeping couple, without waking the other.

Mircocontroller 40 includes another logic port designated as a telephone port 70, which provides a logic signal on a line 72. The logic signal is used to enable and disable a telephone interface so that the telephone ringer is rendered inoperative during telephone sleep periods, as described above.

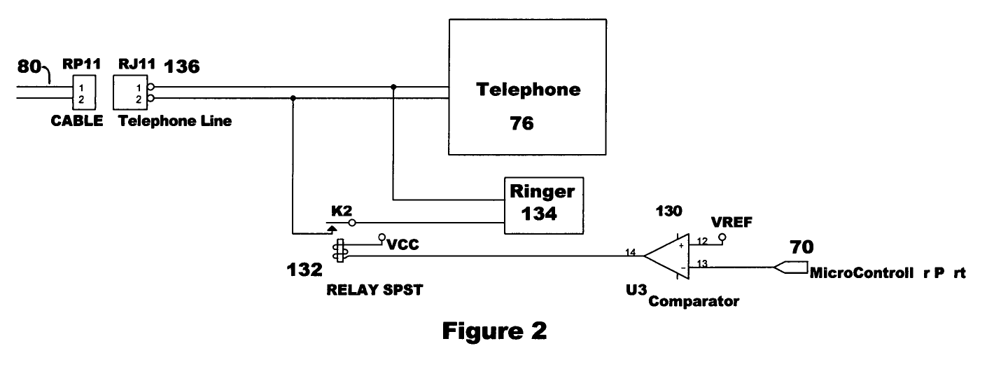

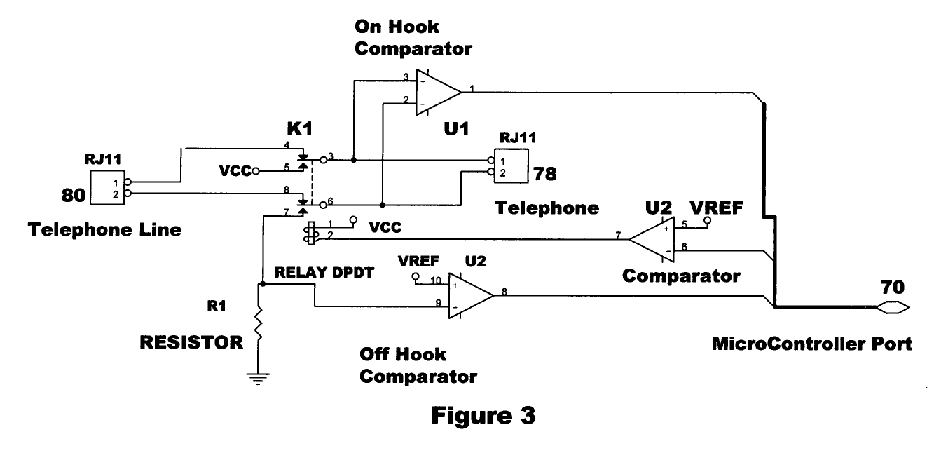

Telephone interface 74 may operate with an optional internal telephone 76 associated with clock radio 10, or may control an external telephone connected to a line 78, which telephone provides telephone service by means of a conventional telephone line 80 connected to telephone interface 74. It will be understood that conventional modular telephone connectors may be used, as is well know in the art. This is described in more detail with respect to FIG. 2 and FIG. 3 below.

Mircocontroller 40 is connected to a computer interface 82 via a bus 84. As described below, clock radio 10 may be programmed via interface 82 with the various wake-up schedules described above.

The various components of clock radio 10 described above are powered by a power supply 86 which is connected to the mains by a plug 88 and line cord 90, in a manner well known in the art. A back-up battery 92 may be provided to power volatile memory, so that stored information is not lost in the case of a power outage. The combination of power supply 86 and back-up battery serves as a built in uninterruptible power supply which allows the device to continue to function during power outages.

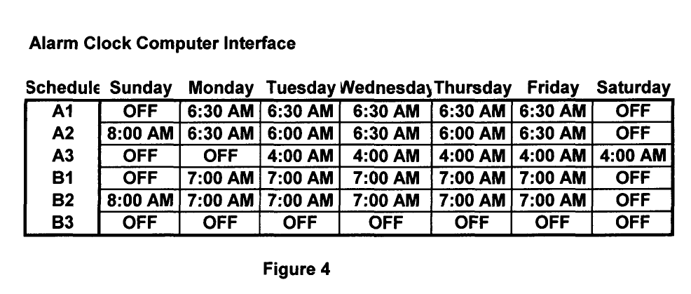

A computer or a personal digital assistant (PDA), collectively referred to herein as a programming system 94, having a display 96, may run software used to program clock radio 10 via computer or PDA interface 82, as described in more detail below with respect to FIG. 4. Programming system 94 may communicate with interface 82 by any one of several means. An infrared, radio frequency or other wireless link may be provided. Alternatively, a memory stick may have appropriate information stored thereon and may be transferred from programming device 94 to interface 82. As yet another alternative, a connection cable 98 (such as an RS-232 link) may be used, but this is generally convenient only when programming device 94 is portable.

Clock radio 10 may be operated and programmed in the manner generally described above by using keyboard 46, which is really a series of buttons, each operating a SPST switch which remains closed as long as its respective button is pushed. Detailed operational instructions are set forth below.

The clock is set by pressing the “clock set” button 100. This will start the large hours digits of indicator 14 blinking. The hours can then be incremented or decremented by pressing the “+” or increment button 102, or “−” or decrement button 104. Pressing the “clock set”button 100 again will increment the display so that the minutes digits of indicator 14 blink. The process is repeated for minutes. Pressing the “clock set” button 100 a third time will cause the AM 16 or PM 18 indicators to flash. Pressing “+” (102) or “−” (104) will change the blinking indicator. Pressing the “clock set” button 100 a fourth time will resume normal operation.

Pressing the “alarm set” button 106 initiates programming of the alarm functions. The “A” alarm display indicator 26 will blink. Pressing “+” (102) or “−” (104) will cause the blinking indicator to change to the “B” alarm display indicator 30. Pressing “alarm set” button 106 again will start the alternate schedule indicator 28 or 32 (shown as 1,2, or 3) blinking. Pressing “+” button (102) will allow selection of one of the alarm schedules. Pressing the “−” button (104) will change that to the alternate alarm. Pressing “alarm set” button 106 again will start all the days of the week of indicators 20 blinking. To set all the days the same, proceed to the next step, described below. To program just one day, press the “+” button 102 or “−” button 104 until the desired day is blinking. Pressing “alarm set” button 106 again will start the hours digits of indicators 26 or 30 blinking. The hours can then be incremented or decremented by pressing the “+” button 102 or “−” button 104. Pressing the “alarm set” button 106 again will increment the display so that the minutes of indicators 26 or 30 blink. The process is repeated for minutes. Pressing the “alarm set” button 106 again will cause the AM or PM portion of indicators 26 or 30 to flash. Pressing “+” (102) or “−” (104) will change the blinking indicator. Pressing the “clock set” button 100 again will start the next day flashing. After programming all the days, pressing the “alarm set” button 106 will resume normal operation. This process is repeated again until all the alarms are programmed.

Pressing the “snooze” button 108 will start a snooze cycle, of for example, ten minutes, as is well known in the art.

Using the alternate alarm button 110 to set an alternate alarm will change any alarm schedule for one use. After that use occurs, the schedule will revert back to the normal schedule. The manner of setting the alternate alarm is similar to that described above, except that alternate alarm button 110 is used.

Pressing alarm off button 112 will turn off any alarm that has sounded.

Pressing the Alarm Disable A button 114 will disable the A alarm function and blank display 26 and 28 until it is pressed again. Pressing the Alarm Disable B button 116 will do the same for user B. This allows the alarm to be turned off for any extended period of time, without having to reprogram it later. Otherwise the alarm will normally continue to function, and need not be reset for the next alarm cycle.

Pressing the Radio button 118 will turn on the radio and will turn on indicator 34. Pressing it a second time will turn off the radio and indicator 34. Pressing the AM/FM button 120 changes the radio band selected. Pressing the “+” button 102 or “−” button 104 will change the station up or down. The frequency selected is shown on the display by means of indicator 34. Indicator 34 is on when the radio is enabled. It is blank otherwise.

The optional telephone 76 will have its ringer disabled during the indicated “do not disturb” period. To set the period, press the “Tel Set” button 122. The Start hours display portion of indicator 22 will blink. The hours can then be incremented or decremented by pressing the “+” button 102 or “−” button 104. Pressing the “Tel Set” button 122 again will increment the display so that the minutes blink. The process is repeated for minutes. Pressing the “Tel Set” button 122 a third time will cause the AM or PM indicator to flash. Pressing “+” (102) or “−” (104) will change the blinking indicator. Pressing the “Tel Set” button 122 a fourth time will repeat the operation for the Stop time shown on indicator 24.

Another option is to have the telephone ringer on time controlled by the selected programs. The ringer can be rendered operative when the latest time for that day of the selected alarm time schedules has been reached, thus allowing the last person to be awakened to sleep without the interruption of an incoming telephone call. This first “default” time may be displayed as the stop telephone sleep time on display indicator 24 (FIG. 1). If the selected schedule for at least one of the first person and the second person does not have a wake up time programmed for a particular day, or it has been programmed as “OFF” (see description of FIG. 4 below), then the stop telephone sleep time may be a settable or preprogrammed second default time, such as for example, 1:00 PM. This is based on the assumption that the couple, even if sleeping late, may wish to receive phone calls after that time in the afternoon. However, as indicated, under certain circumstances, such as for example, night shift work, this second default may be set for a completely different time.

Pressing the “Alarm Set” button 106, followed by the “Radio” button 118, will allow the selection of both the alarm radio station, displayed on 36, and the alarm volume, using the normal radio controls. Pressing the “Alarm Set button again, will end the radio set mode.

Referring to FIG. 2, a version of telephone interface 74 for use with a telephone 76 which is built in to clock radio 10 is illustrated. A logic signal in the form of the presence or absence of a voltage is provided from telephone port 70 of microcontroller 40 on line 72, to the inverting input of a voltage comparator 130. The non-inverting input of comparator 130 is connected to a reference voltage of approximately one half of the logic “on” level. The output of comparator 130 is connected to one side of the coil of a relay 132. The other side of the coil of relay 132 is connected to supply voltage.

Relay 132 is a single pole relay. The pole is connected in series with a line to a ringer 134 associated with telephone 76. Telephone 76 is connected to a standard modular telephone connector 136, which is connected to a conventional telephone line 80. Thus, during telephone sleep periods, relay 132 serves to disconnect ringer 134 so that telephone 76 will not ring, and sleep will not be disturbed. However, telephone 76 will otherwise be fully operational because it is always connected to telephone line 80, and can be used to make telephone calls at any time, whether in the telephone sleep mode or not.

Referring to FIG. 3 an external telephone interface disconnects the telephone from the phone line during the sleep period. This prevents the phone from ringing. This is accomplished by the microcontroller 40 (FIG. 1) enabling relay K1. Comparator U2 monitors the voltage developed across R1. When the voltage is low, the telephone is on hook. If the telephone is lifted off hook, the voltage rises, since the impedance of the telephone drops. When the off hook mode is detected by the micro controller 40, it releases relay K1 to reconnect the telephone to the line, so that an outgoing call can be made. When the telephone is replaced on hook, comparator U1 will detect the increase in voltage across the line, due to the higher load impedance, and will signal the micro controller 40 that the telephone is back on hook. The microcontroller 40 will then activate K1 again, disconnecting the telephone. At the end of the sleep period, the telephone will be connected to the line, by the microcontroller 40.

The operation for the built in phone is simpler. Here, the ringer is disabled during the sleep period by K2, and re-enabled at the end of the period. The telephone itself is always connected to the line, so outgoing calls can be made at any time.

FIG. 4 illustrates a typical screen that can be generated by the software in programming device 94 to be shown on display 96, to allow programming of alarm clock radio 10. The first person, designated as person A, can have three different schedules A1, A2 and A3. The second person, designated as person B, can have three different schedules B1, B2 and B3. Each schedule can have a different wake up time for every day of the week. These times may be programmed by entering a programming mode and moving the cursor on the display to the cell for that day (right or left) and schedule (up or down) and entering the desired time for the alarm to be activated. If no alarm is desired, such as when a person wishes to sleep until he or she wakes up, then the cell is left blank or the word OFF is entered. After all desired cells have been filled in, a save command is used to save the data. If a change is desired, then the programming mode is again entered, the cursor is moved to the cell in which a change is desired, and the previous entry is written over. After all desired changes have been made, the data is saved.

When the programming has been accomplished, the data must be transferred from the programming device to alarm clock radio 10. If the programming device is a PDA, interface 82 may be a simple infrared interface. The data is received by micro controller 40 on line 84, as discussed above with respect to FIG. 1. If programming device 94 is a computer, it may be connected to an infrared interface, to transfer the data to interface 82. Alternatively, hardware configurations for the programming device 94 and interface 82 may include a cable connection, a memory stick, a radio frequency link (such as for example the Bluetooth standard), or any other suitable information transfer technology.

While the invention has been described with reference to specific embodiments, it will be understood that variations and modifications may be made by those skilled in the art. For example, the radio may have provisions for other music sources, such as a tape player, a CD player, or a storage device for MP3 music files, which may be used as a source of music to be played, or may be routed to a pillow speaker. The display may include provision for showing the date, in addition to the day of the week.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. An alarm clock comprising:
a time keeping circuit;
a display for displaying a time provided by said time keeping circuit;
an alarm time memory including alarms for a first person and for a second person, said alarms for said first person and for said second person including a plurality of schedules, each schedule being separately programmable for a different time for each day of the week;
a selector for selecting which of said schedules it to be an active alarm; and
apparatus for making a person aware that an alarm time has been reached.

2. The alarm clock of claim 1, further comprising:
an input device or entering an alternate alarm time to replace a single time for a single day of the week.

3. The alarm clock of claim 2, wherein said alternate alarm time is used only once before said alarm clock reverts to a preselected schedule.

4. The alarm clock of claim 2, wherein after said alternate alarm time is used, an alarm is generated on a preexisting schedule.

5. The alarm clock of claim 1, wherein said apparatus includes a pillow pad for at least one of said first person and said second person.

6. The alarm clock of claim 1, wherein said apparatus includes a pillow pad for said first person and a pillow pad for said second person.

7. The alarm clock of claim 1, further comprising a sound generating system.

8. The alarm clock of claim 7, wherein said sound generating system includes at least one of a radio receiver, a tape player, a CD player and a MP3 file player.

9. The alarm clock of claim 1, further comprising:
a controller for controlling whether a telephone ringer is active between selected times of a day.

10. The alarm clock of claim 9, wherein said controller renders said telephone ringer active at the latest alarm time of alarm times selected by said selector.

11. The alarm clock of claim 9, wherein said display comprises a portion for displaying when said telephone ringer is rendered inactive and when said telephone ringer is rendered active, by said controller.

12. The alarm clock of claim 1, further comprising:
a telephone, and
a controller for controlling whether a telephone ringer is active between selected times of a day.

13. The alarm clock of claim 12, wherein said display comprises a portion for displaying when said telephone ringer is rendered inactive and when said telephone ringer is rendered active by said controller.

14. The alarm clock of claim 1, wherein said display comprises portions for displaying current time, an alarm time for the first person and an alarm for the second person.

15. The alarm clock of claim 1, wherein said display comprises portions for displaying which of said plurality of schedules has been selected for at least one of said first person and said second person.

16. The alarm clock of claim 1, wherein said display comprises portions for displaying which of said plurality of schedules has been selected for said first person and said second person.

17. The alarm clock of claim 1, wherein said display comprises portions for displaying a current day of the week.

18. An alarm clock comprising:
a time keeping circuit;
a display for displaying the time provided by said time keeping circuit;
an alarm time memory for storing at least one first alarm time for a first person and at least one second alarm time for a second person;
a first source of electrical energy being activated when said first alarm time is reached;
a second source of electrical energy being activated when said second alarm time is reached;
a first vibration source for placement in a first pillow responsive to set first source; and
a second vibration source for placement in a second pillow responsive to said second source.

19. The alarm clock of claim 18, wherein said alarms for said first person and for said second person including a plurality of schedules, each schedule being separately programmable for a different time for each day of the week

20. An alarm clock comprising:
a time keeping circuit;
a display for displaying the time provided by said time keeping circuit; and
a telephone sleep alarm, said telephone sleep alarm defining a start time and an end time, said alarm clock disabling a ringer on a telephone between said start time and said end time.

21. The alarm clock of claim 20, further comprising:
an alarm time memory including an alarm time for a first person and an alarm time for a second person, said end time on a given day being a later of said alarm time for said first person and said alarm time for said second person.

22. The alarm clock of claim 20, further comprising:
an alarm time memory including an alarm time for a first person and an alarm time for a second person, said end time on a given day being a predetermined default time if either of said alarm time for said first person and said alarm time for said second person is not selected.

23. The alarm clock of claim 20, further comprising:
an alarm time memory including alarms for a first person and for a second person, said alarms for said first person and for said second person including a plurality of schedules, each schedule being separately programmable for a different time for each day of the week.

24. The alarm clock of claim 20, further comprising a telephone interface, said telephone interface comprising:
a telephone disable and restore circuit for disabling said telephone during a selected time;
a sense circuit for detecting whether the telephone is off hook; and
a restore circuit responsive to said sense circuit for operating said disable and restore circuit to reconnect the telephone so that a dial tone is available, and telephone calls can be made.

25. The alarm clock of claim 24, further comprising:
a telephone, built into said alarm clock, and
a disable circuit for disabling the ringer of said telephone between said start time and said end time.

26. An alarm clock comprising:
a time keeping circuit;
a display for displaying the time provided by said time keeping circuit;
an alarm time memory for storing a plurality of alarm times; and
an interface for receiving a plurality of alarm times to be stored in said alarm time memory.

27. The alarm clock of claim 26, wherein said interface is configured to receive said alarm times from a digital device.

28. The alarm clock of claim 27, in combination with said digital device.

29. The combination of claim 28, wherein said digital device is one of a computer, a personal digital assistant and a memory stick.

30. The combination of claim 28, wherein said interface communicates with said digital device by one of an infra-red link, a radio link and a direct electrical connection.

31. The combination of claim 30, wherein said direct electrical connection comprises an RS-232 or USB link.

32. A method for operating an alarm clock, comprising:
programming a digital device with at least one schedule; and
transferring the schedule to the alarm clock.

33. The method of claim 32, further comprising setting the alarm clock to provide alarms in accordance with the alarm schedule.

34. The method of claim 32, wherein the at least one schedule comprises alarms for a first person and for a second person, said alarms for said first person and for said second person including a plurality of schedules, each schedule being separately programmable for a different time for each day of the week.

35. The method of claim 32, wherein the at least one schedule comprises times for rendering a telephone ringer operative and inoperative.

36. The method of claim 32, further comprising providing an uninterruptible power supply to power said alarm clock during a power failure.
